(19) United States
(12) Patent Application Publication
(10) Pub. No.: US 2022/0168863 A1
(43) Pub. Date: Jun. 2, 2022

(54) ORBITAL POLISHER

(71) Applicant: MILWAUKEE ELECTRIC TOOL CORPORATION, Brookfield, WI (US)

(72) Inventors: Masroor Ahmad, Franklin, WI (US); Scott R. Fischer, Menomonee Falls, WI (US); Peter A. Borowski, Milwaukee, WI (US)

(21) Appl. No.: 17/537,779

(22) Filed: Nov. 30, 2021

Related U.S. Application Data
(60) Provisional application No. 63/119,980, filed on Dec. 1, 2020.

(51) Int. Cl. B24B 23/03

(52) U.S. Cl. CPC B24B 23/03

(57) ABSTRACT

A polishing tool includes a housing having a motor housing portion and a handle portion extending rearwardly therefrom, a motor located within the motor housing portion, a trigger proximate the handle portion and configured to selectively activate the motor, a battery pack coupled to the handle portion of the housing and configured to provide electrical power to the motor when the trigger is actuated, and a backing plate coupled to the motor to receive torque therefrom, causing the backing plate to move in one or more of a rotating manner and an orbiting manner. The motor housing portion includes a maximum width of two times or less than a maximum width of the handle portion.

### CROSS-REFERENCE TO RELATED APPLICATIONS

This application claims priority to co-pending U.S. Provisional Patent Application No. 63/119,980 filed on Dec. 1, 2020, the entire content of which is incorporated herein by reference.

### FIELD OF THE INVENTION

The present invention relates to a powered oscillating tool, and more particularly to a battery powered orbital polisher.

### BACKGROUND OF THE INVENTION

Orbital polishing machines generally include a pad to which an accessory (e.g., a polishing or buffing pad or cover) is attachable for polishing a work surface. In random orbital polishing machines, the assembly can additionally mount the pad to an off axis bearing via an eccentric member that is coupled to the drive shaft of the motor, thereby defining a single eccentric orbit.

### SUMMARY OF THE INVENTION

The present invention provides, in one aspect, a polishing tool including a housing including a motor housing portion and a handle portion extending rearwardly therefrom, a motor located within the motor housing portion, a trigger proximate the handle portion and configured to selectively activate the motor, a battery pack coupled to the handle portion of the housing and configured to provide electrical power to the motor when the trigger is actuated, and a backing plate coupled to the motor to receive torque therefrom, causing the backing plate to move in one or more of a rotating manner and an orbiting manner. The motor housing portion includes a maximum width of two times or less than a maximum width of the handle portion.

The present invention provides, in another aspect, a polishing tool including a housing including a motor housing portion and a handle portion extending rearwardly therefrom, the housing defining a longitudinal axis, a motor located within the motor housing portion, a trigger proximate the handle portion configured to selectively activate the motor, a printed control board assembly positioned within the motor housing portion and configured to control operation of the motor in response to actuation of the trigger, the printed control board assembly defining a plane that is intersected by the longitudinal axis at an oblique angle and a backing plate coupled to the motor to receive torque therefrom, causing the backing plate to move in one or more of a rotating manner and an orbiting manner.

The present invention provides, in another aspect, a polishing tool including a housing including a motor housing portion and a handle portion extending rearwardly therefrom, a motor located within the motor housing portion, the motor having a motor shaft defining a rotational axis, a trigger proximate the handle portion configured to selectively activate the motor, a battery pack coupled to the handle portion of the housing and configured to provide electrical power to the motor when the trigger is actuated, an output shaft coupled to the motor shaft via a right-angle gear train to receive torque from the motor, a backing plate coupled to the output shaft, causing the backing plate to move in one or more of a rotating manner and an orbiting manner, and a counterweight mechanism coupled to the output shaft between the right-angle gear train and the backing plate. The counterweight mechanism including a plate having a first surface and a second surface opposite the first surface, a first counterweight coupled to the first surface of the plate, and a second counterweight coupled to the second surface of the plate.

Other features and aspects of the invention will become apparent by consideration of the following detailed description and accompanying drawings.

### BRIEF DESCRIPTION OF THE DRAWINGS

FIG. 1 is a perspective view of a polishing tool in accordance with an embodiment of the invention.

FIG. 2 is a side view of the polishing tool of FIG. 1

FIG. 3 is a top view of the polishing tool of FIG. 1.

FIG. 4 is a cross-sectional view of the polishing tool of FIG. 1.

FIG. 5 is a cross-sectional view of a backing plate of the polishing tool of FIG. 1.

FIG. 6 is a partial cutaway view of a portion polishing tool of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

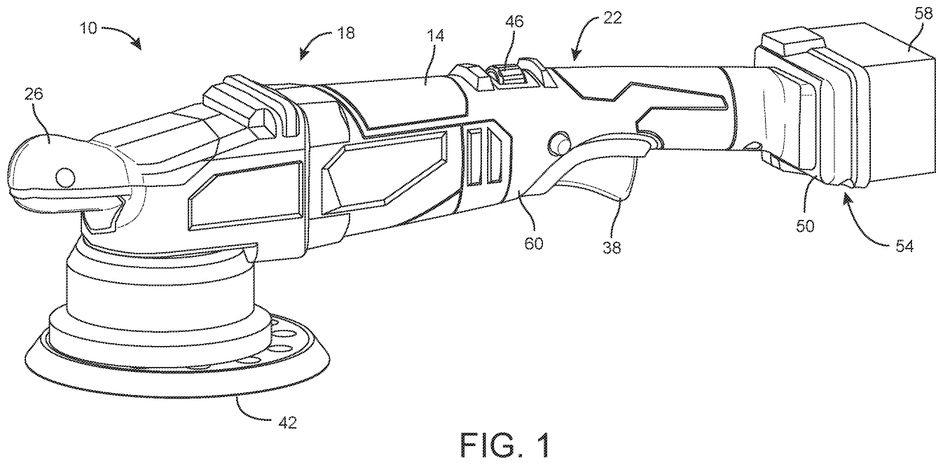

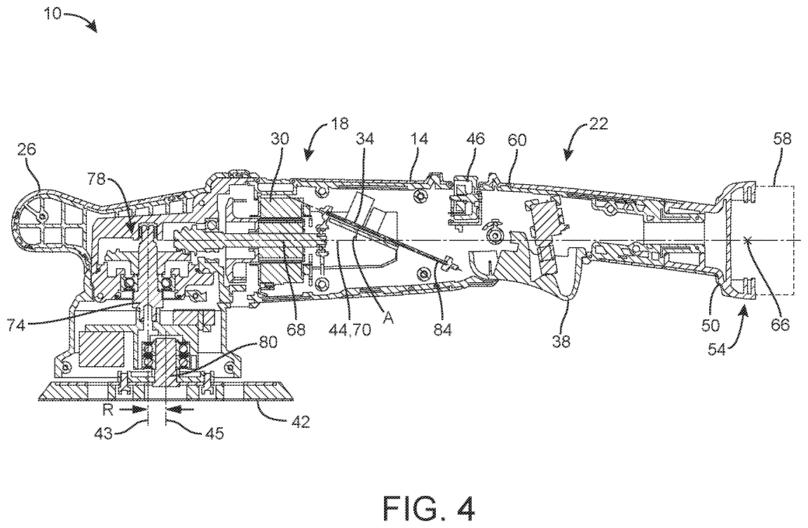

FIGS. 1-4 illustrate a polishing tool 10 including a housing 14 having a motor housing portion 18 and a handle portion 22 extending rearwardly from the motor housing portion 18. The tool 10 also includes a pommel grip 26 extending from the front of the housing 14 that is graspable by a user of the tool 10 in addition to the handle portion 22. The motor housing portion 18 may be also used as an additional or third grip portion, as described in more detail below. A brushless electric motor 30 (FIG. 4) and a printed control board assembly (PCBA) 34 that controls operation of the motor 30 are each located within the motor housing portion 18. A trigger 38 extends from the bottom surface of the handle portion 22 and is configured to selectively activate the motor 30 by providing an electrical input to the PCBA 34.

The tool 10 also includes a backing plate 42 coupled to the motor 30 to receive torque therefrom, causing the backing plate 42 to rotate and/or orbit about parallel first and second vertical axes 43, 45 (FIG. 4), each of which is oriented perpendicular to a horizontal longitudinal axis 44 along which the housing 14 generally extends. A polishing accessory (e.g., a foam or microfiber pad or cover) is attachable to the backing plate 42 for movement therewith. The tool 10 further includes a variable speed dial 46 positioned on the top surface of the handle portion 22 to adjust the maximum rotary speed of the motor 30 when the trigger 38 is depressed (FIG. 1).

The handle portion 22 includes a rear end 50 defining a battery receptacle 54 that selectively receives a battery pack 58 and a front end 60 contiguous with the rear of the motor housing portion 18. The battery receptacle 54 defines an attachment axis 66 (FIG. 3) along which a battery pack 58 is slidable for attachment to the battery receptacle 54 to provide electrical power to the PCBA 34 and to the motor 30 when the trigger 38 is depressed.

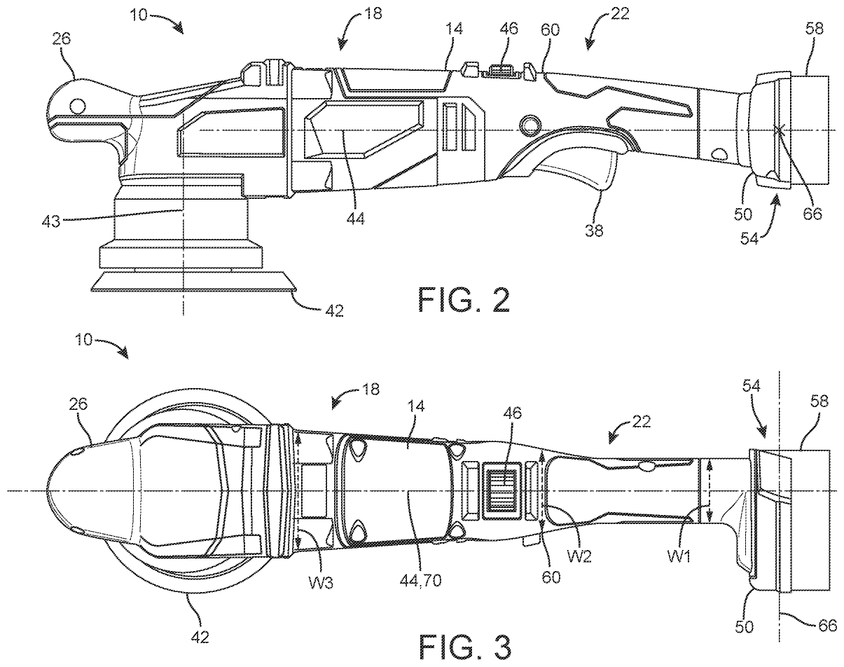

With reference to FIG. 4, the motor 30 includes a motor shaft 68 that defines a rotational axis 70 which, in the illustrated embodiment of the tool 10, is coaxial with the longitudinal axis 44 of the housing 14. As shown in FIGS. 2 and 3, the attachment axis 66 of the battery receptacle 54 is oriented transverse to each of the rotational axis 70 of the motor 30, the longitudinal axis 44 of the housing 14, and the vertical axis 43. In other words, the attachment axis 66 laterally extends relative to the housing 14 in a horizontal direction, which reduces the height of the tool 10 proximate the rear end 50 of the handle portion 22 (from the frame of reference of FIG. 2).

With reference to FIG. 4, the motor shaft 68 is coupled to an output shaft 74 of the tool 10, which is coaxial with the vertical axis 43, via a right-angle gear train 78. The output shaft 74 (and the vertical axis 43), therefore, are oriented transverse to the rotational axis 70 of the motor 30 and the longitudinal axis 44 of the housing 14. The first vertical axis 43 extends centrally through the output shaft 74 and the second vertical axis 45 extends centrally through a second offset output shaft 80. An orbit radius R is defined as the distance between the first and second vertical axes 43, 45. In some embodiments, the polisher 10 may have a first orbit radius (e.g., 15 mm) or a second orbit radius (e.g., 21 mm). In other embodiments, the orbit radius R may be an alternative radius.

The PCBA 34 is positioned within the motor housing portion 18 between the trigger 38 and the motor 30. And, the PCBA 34 defines a plane 84 that is intersected by the longitudinal axis 44 of the housing 14 and the rotational axis 70 of the motor 30 at an oblique angle A. In the illustrated embodiment, the angle A is in a range between 10 degrees and 60 degrees, and in some embodiments, is about 25 degrees. The inclined orientation of the PCBA 34 reduces the length of the motor housing portion 18 and therefore, the overall length of the housing 14 and the tool 10.

With reference to FIG. 3, the housing 14 has an ergonomic profile to allow the operator to easily grip different portions of the housing 14 during operation. For example, the handle portion 22 has a width W1, the motor housing portion 18 has a tapered profile defining a width W2 proximate the rear end of the motor housing portion 18 and a width W3 adjacent the front end of the motor housing portion 18. The widths W1, W2, W3 are each measured in a cross-sectional plane that is perpendicular to the longitudinal axis 44 of the housing 14. In the illustrated embodiment, the width W1 of the handle portion 22 (e.g., the maximum width of the handle portion 22) is approximately 1.50 inches, the width W2 of the motor housing portion 18 is approximately 2.30 inches, and the width W3 of the motor housing portion 18 (e.g. the maximum width of the motor housing portion 18) is approximately 2.80 inches. In other embodiments, the handle portion 22 may have a maximum width W1 in a range of 1 inch to 2 inches and the motor housing portion 18 may have a maximum width W3 in a range of 2 inches to 4 inches.

In the illustrated embodiment, the maximum width W3 of the motor housing portion 18 is approximately 1.9 times the maximum width W1 of the handle portion 22. As such, the maximum width W3 of the motor housing portion 18 is two times or less than the maximum width W1 of the handle portion 22. In other embodiments, the maximum width W3 of the motor housing portion 18 may be approximately 2.5 times or less than the minimum width W1 of the handle portion 22. In other embodiments, the maximum width W3 of the motor housing portion 18 is approximately 1.5 times or less than the minimum width W1 of the handle portion 22.

During operation, the user may grasp the handle portion 22 of the tool 10 with one hand and grasp the motor housing 18 or the pommel grip 26 to apply more leverage on the polisher 10. Due to the thin construction of the housing 14, and in particular the thin construction of the motor housing portion 18, the maximum width W3 of the motor housing portion 18 is small enough that an average size user can easily grasp the motor housing portion 18 with one hand, which improves the ergonomics of the tool 10.

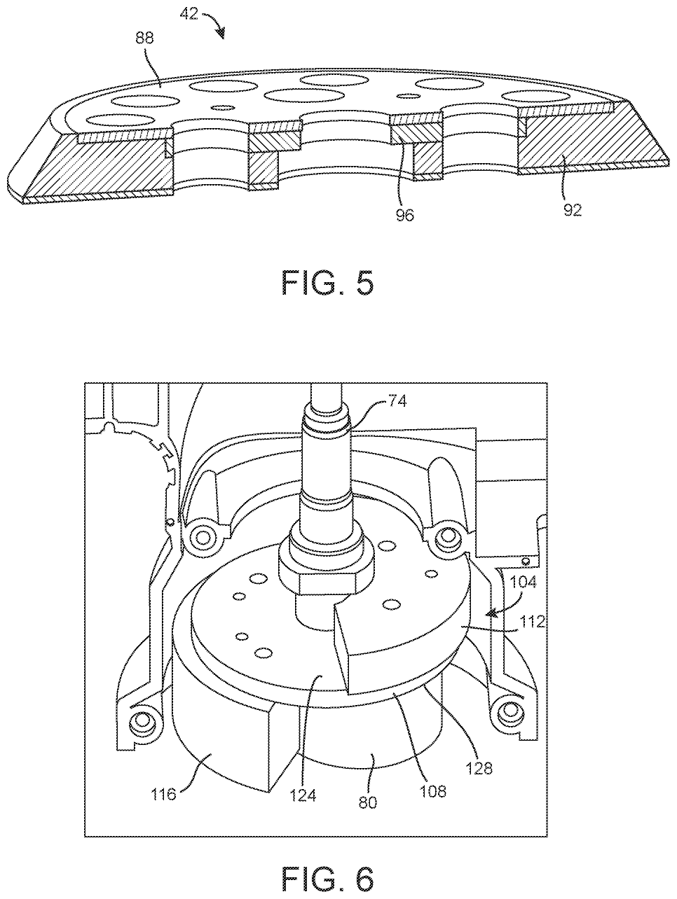

Now with reference to FIGS. 5 and 6, the backing plate 42 includes a hub 88 coupled to the offset output shaft 80, a body portion 92 coupled to the hub 88, and an insert 96 positioned between the hub 88 and the body portion 92. In the illustrated embodiment, the hub 88 is formed of a fiberglass material, the body portion 92 is formed of polyurethane (e.g., polyurethane leather), and the insert 96 is formed of metal. The size or weight of the insert 92 may be adjusted to adjust the overall weight of the backing plate 42. The backing plate 42 may also include a hook and loop attachment mechanism coupled to the body portion 92 to selectively receive the polishing accessory. The backing plate 42 may have either a first diameter or a second diameter. For example, the first diameter may be five inches and the second diameter may be six inches.

Typically, the backing plates of other polishing tools are tuned to work with a specific orbit radius of the polishing tool. In other words, a backing plate having a five inch diameter (e.g., the first diameter) has to be used with a polishing tool having an orbit radius of 15 mm (e.g., the first orbit radius). And, a backing plate having a six inch diameter (e.g., the second diameter) has to be used with a polishing tool having an orbit radius of 21 mm (e.g., the second orbit radius). Interchanging these backing pads on the same polishing tool could cause unwanted vibration through the handle portion of the polisher. The polishing tool 10, in some embodiments, includes a counterweight mechanism 104 (FIG. 6) specifically tuned to work with backing plates 42, the weights of which are also tuned by selecting a metal insert 96 of an appropriate size, having either a first diameter or a second diameter.

With continued reference to FIG. 6, the counterweight mechanism 104 is coupled to the output shaft 74 between the right-angle gear train 78 and the backing plate 42. The counterweight mechanism 104 includes a plate 108, a first counterweight 112, and a second counterweight 116. The plate 108 includes a first, upper surface 124 and a second, lower surface 128 opposite the first surface 124. The first counterweight 112 is coupled to the upper surface 124 on a first side of the output shaft 74 and the second counterweight 116 is coupled to the lower surface 128 on a second side of the output shaft 74. In the illustrated embodiment, the first and second counterweights 112, 116 each have a generally C-shaped geometry such that each counterweight 112, 116 extends 180 degrees or less around the output shaft 74. Further, the second, offset output shaft 80 is rotatably coupled to the lower surface 128 of the plate 108 and positioned opposite the first counterweight 112.

Although the invention has been described in detail with reference to certain preferred embodiments, variations and modifications exist within the scope and spirit of one or more independent aspects of the invention as described.

Various features of the invention are set forth in the following claims.

What is claimed is:

1. A polishing tool comprising:
a housing including a motor housing portion and a handle portion extending rearwardly therefrom;
a motor located within the motor housing portion;
a trigger proximate the handle portion and configured to selectively activate the motor;
a battery pack coupled to the handle portion of the housing and configured to provide electrical power to the motor when the trigger is actuated; and
a backing plate coupled to the motor to receive torque therefrom, causing the backing plate to move in one or more of a rotating manner and an orbiting manner,
wherein the motor housing portion includes a maximum width of two times or less than a maximum width of the handle portion.

2. The polishing tool of claim 1, wherein the motor includes a motor shaft that defines a rotational axis.

3. The polishing tool of claim 2, further comprising a receptacle on the handle portion of the housing defining an attachment axis along which the battery pack is slidable, and wherein the attachment axis is oriented transverse to the rotational axis of the motor.

4. The polishing tool of claim 3, wherein the trigger is configured to be actuated in a vertical direction relative to the handle portion, and wherein the attachment axis laterally extends relative to the housing in a horizontal direction.

5. The polishing tool of claim 2, further comprising:
an output shaft coupled to the backing plate; and
a right-angle gear train positioned between the motor shaft and the output shaft.

6. The polishing tool of claim 2, further comprising a printed control board assembly positioned within the motor housing portion and configured to control operation of the motor in response to actuation of the trigger.

7. The polishing tool of claim 6, wherein the printed circuit board defines a plane that is intersected by the rotational axis of the motor shaft at an oblique angle.

8. The polishing tool of claim 7, wherein the printed control board assembly is positioned between the trigger and the motor.

9. A polishing tool comprising:
a housing including a motor housing portion and a handle portion extending rearwardly therefrom, the housing defining a longitudinal axis;
a motor located within the motor housing portion;
a trigger proximate the handle portion configured to selectively activate the motor;
a printed control board assembly positioned within the motor housing portion and configured to control operation of the motor in response to actuation of the trigger, the printed control board assembly defining a plane that is intersected by the longitudinal axis at an oblique angle; and
a backing plate coupled to the motor to receive torque therefrom, causing the backing plate to move in one or more of a rotating manner and an orbiting manner.

10. The polishing tool of claim 9, wherein the printed control board assembly is positioned between the trigger and the motor.

11. The polishing tool of claim 9, wherein the oblique angle is in a range between 10 degrees and 60 degrees.

12. The polishing tool of claim 9, further comprising a battery pack coupled to the handle portion of the housing and configured to provide electrical power to the motor when the trigger is actuated.

13. The polishing tool of claim 9, wherein the motor housing portion includes a maximum width of two times or less than a maximum width of the handle portion.

14. A polishing tool comprising:
a housing including a motor housing portion and a handle portion extending rearwardly therefrom;
a motor located within the motor housing portion, the motor having a motor shaft defining a rotational axis;
a trigger proximate the handle portion configured to selectively activate the motor;
a battery pack coupled to the handle portion of the housing and configured to provide electrical power to the motor when the trigger is actuated;
an output shaft coupled to the motor shaft via a right-angle gear train to receive torque from the motor;
a backing plate coupled to the output shaft, causing the backing plate to move in one or more of a rotating manner and an orbiting manner; and
a counterweight mechanism coupled to the output shaft between the right-angle gear train and the backing plate, the counterweight mechanism including
a plate having a first surface and a second surface opposite the first surface,
a first counterweight coupled to the first surface of the plate, and
a second counterweight coupled to the second surface of the plate.

15. The polishing tool of claim 14, wherein the first counterweight is positioned on a first side of the output shaft and the second counterweight is positioned on a second side of the output shaft.

16. The polishing tool of claim 15, wherein the first and second counterweights each have a generally C-shaped geometry.

17. The polishing tool of claim 15, wherein the first and second counterweights each extend 180 degrees or less around the output shaft.

18. The polishing tool of claim 14, wherein a second output shaft is rotatably coupled to the second surface of the plate.

19. The polishing tool of claim 18, wherein the backing plate includes a hub coupled to the second output shaft, a body portion coupled to the hub, and an insert positioned between the hub and the body portion.

20. The polishing tool of claim 19, wherein the insert is formed of metal.
